(19) United States
(12) Patent Application Publication
(10) Pub. No.: US 2002/0198296 A1
(43) Pub. Date: Dec. 26, 2002

(54) Terpolymers and rubber mixtures containing special mineral oils

(76) Inventors: Adrian Rawlinson, Leverkusen (DE); Stephen Pask, Dormagen (DE); Peter Wendling, Leverkusen (DE)

Correspondence Address: Patent Department, Bayer Corporation, 100 Bayer Road, Pittsburgh, PA, 15205-9741, US

(21) Appl. No.: 10/132,053

(22) Filed: Apr. 25, 2002

(30) Foreign Application Priority Data
Apr. 30, 2001 (DE) 10121161.9

(51) Int. Cl. C08K 5/41; C08K 5/01

(52) U.S. Cl. 524/173; 524/474

(57) ABSTRACT

The invention relates to rubber mixtures containing a terpolymer (NSBR) based on an unsaturated olefinic nitrile, a vinyl aromatic compound and a conjugated diene, a non-polar rubber and a special mineral oil. The rubber mixtures according to the present invention have, in particular, an improved wet-skid behavior compared to rubber mixtures to which the conventional aromatic mineral oils have been added.

### FIELD OF THE INVENTION

The present invention relates to rubber mixtures containing a terpolymer (NSBR) based on an unsaturated olefinic nitrile, a vinyl aromatic compound and a conjugated diene, as well as a non-polar rubber and a special mineral oil.

### BACKGROUND OF THE INVENTION

It is known for economic and technical reasons to add aromatic oils to styrene-butadiene rubbers or butadiene rubbers. By extending the rubbers with mineral oils, their processing behavior, for example, can be improved without adversely affecting the physical properties of the rubbers.

The aromatic oils used to date for this purpose have the disadvantage however that they often contain constituents that are carcinogenic. Attempts have, therefore, been made to find alternatives that do not have a carcinogenic effect, for the aromatic oils used to date. It has now been found that mineral oils containing a dimethyl sulfoxide (DMSO) extract (corresponding to IP346 test method) in an amount of ≦3 wt. % and are, therefore, not regarded as carcinogenic, appear suitable for addition to a very wide range of rubbers. As representatives of such special mineral oils the following may be mentioned by way of example: mild extraction solvate (MES) as well as treated distillate aromatic extract (TDAE). Such mineral oils are marketed for example by Shell, Esso, BP and Nynas.

The disadvantage, however, is that rubbers to which the aforementioned special mineral oils such as TDAE and MES have been added suffer a deterioration in quality, in particular as regards wet-skid behavior. Therefore, this means that such rubber mixtures are not particularly suitable for use in producing, for example, tire treads.

### SUMMARY OF THE INVENTION

Accordingly, the object of the present invention is to provide rubber mixtures that can be mixed and/or extended with non-carcinogenic mineral oils and that have comparable or better technical qualities than rubber mixtures to which hitherto conventional aromatic mineral oils have been added. In particular, the rubber mixtures according to the present invention should have an improved wet-skid behavior.

This object has been achieved by adding terpolymers (NSBR) based on an unsaturated olefinic nitrile, a vinyl aromatic compound and a conjugated diene to rubber mixtures that do not contain carcinogenic mineral oils.

The present invention accordingly provides rubber mixtures comprising at least

a) a non-polar rubber,

b) a terpolymer comprising an olefinically unsaturated nitrile, a vinyl aromatic compound and a conjugated diene, and

c) a mineral oil that contains a DMSO extract in an amount of ≦3 wt. %, the component a) being present in amounts of 1 to 99 parts by weight, the component b) being present in amounts of 1 to 99 parts by weight and the component c) being present in amounts of 1 to 50 parts by weight, in each case referred to the total amount of rubber.

### DETAILED DESCRIPTION OF THE INVENTION

Rubber mixtures are preferred in which the component a) is present in amounts of 5 to 95 parts by weight, preferably 20 to 80 parts by weight, the component b) is present in amounts of 5 to 95 parts by weight, preferably 20 to 80 parts by weight, and the component c) is present in amounts of 5 to 40 parts by weight, preferably 5 to 25 parts by weight, in each case with respect to the total amount of rubber.

As non-polar rubbers, there may be used for the rubber mixtures according to the present invention, natural rubbers (NR) as well as corresponding synthetic rubbers such as polybutadienes (BR), styrene-butadiene copolymers (SBR), polyisoprene rubbers (IR), isoprene-butadiene rubbers, isoprene-butadiene-styrene rubbers (S-SIBR) and ethylene-propylene-diene terpolymers (EPDM), preferably SBR, BR, IR and NR. Most preferred are BR and SBR.

The aforementioned non-polar rubbers are generally known and are produced, for example, by free-radical emulsion polymerization, by free-radical solution polymerization, by anionic or cationic polymerization, or by polymerization with Ziegler-Natter catalysts.

Obviously, the aforementioned rubbers may be used individually or in arbitrary mixtures with one another in the rubber mixture according to the present invention. If different rubbers are mixed with one another, then the amount of the rubbers used is governed by, among other things, the respective intended use and application of the rubber mixture according to the present invention. The quantitative ratio and/or mixing ratio are therefore, suitably adapted thereto.

The terpolymer used as component b) in the rubber mixtures according to the present invention is based, as mentioned hereinbefore, on unsaturated olefinic nitriles, vinyl aromatic compounds and conjugated dienes.

As conjugated dienes, the following in particular are suitable: 1,3-butadiene, 2,3-dimethyl-1,3-butadiene, 2-methyl-1,3-butadiene, 2-ethyl-1,3-butadiene, 1,3-pentadiene, 2-methyl-1,3-pentadiene, 1,3-hexadiene, 2-phenyl-1,3-butadiene, 3,4-dimethyl-1,3-hexadiene, 1,3-heptadiene, 1,3-octadiene, 4,5-diethyl-1,3-octadiene, 3-methyl-1,3-pentadiene, 4-methyl -1,3-pentadiene or mixtures of the aforementioned dienes. 1,3-butadiene and 2-methyl-1,3-butadiene are preferably used as conjugated dienes. 1,3-butadiene is more preferred.

As vinyl aromatic compounds, there may be mentioned those that contain 8 to 16 carbon atoms, such as styrene, α-methylstyrene, 2-methylstirene, 3-methylstirene, 4-methylstirene, 4-cyclohexylstirene, 4-p-toluenestirene, p-chlorostyrene, p-bromostyrene, 4-tert.-butylstyrene, 1-vinyinaphthalene and 2-vinylnaphthalene or mixtures thereof. Styrene is preferred.

As olefinically unsaturated nitrites for the synthesis of the terpolymers, the following may be used: acrylonitrile, methacrylonitrile, ethylacrylonitrile, crotonitrile and 2-pentenenitrile or mixtures thereof. Acrylonitrile is preferred.

The optimum ratio of the aforementioned monomers in the terpolymer used according to the present invention may easily be determined by appropriate preliminary experiments, the optimum mixing ratio being governed by, among other things, the respective intended use of the rubber mixtures according to the present invention.

The terpolymers to be used according to the present invention generally contain the conjugated dienes in amounts of e.g. 40 to 89 wt. %, the vinyl aromatic compounds in amounts of e.g. 10 to 40 wt. %, and the olefinically unsaturated nitriles in amounts of e.g. 1 to 50 wt. %, the amounts of the individual components being made up to 100 wt. %.

Preferably the conjugated dienes are used in amounts of 40 to 80 wt. %, the vinyl aromatic compounds in amounts of 10 to 35 wt. %, and the olefinically unsaturated nitriles in amounts of 10 to 40 wt. %.

Depending on the amounts of the starting compounds that are used, the glass transition temperature of the terpolymers used according to the present invention is e.g. −60° to 0° C., preferably −45° to −15° C.

The NSBR terpolymers used according to the present invention are described in more detail, for example, in EP-A-537 640, U.S. Pat. No. 5,310,815 as well as U.S. Pat. No. 5,225,479.

As component c) there are added to the rubber mixtures according to the present invention, mineral oils that contain a DMSO extract of ≦3 wt. % and that are not considered to be carcinogenic.

Preferably, the following are used as mineral oils: mild extraction solvate (MES), treated distillate aromatic extract (TDAE) as well as mineral oils such as naphthenic oils or hydrogenated naphthenic oils.

MES and TDAE are preferably used.

The chemical compositions of the aforementioned mineral oils used according to the present invention are known in the literature.

The mineral oils may be used individually or as mixtures with one another. The optimum mixing ratio can easily be determined by appropriate preliminary experiments.

Typical properties of MES oil and TDAE oil are given in the following Tables:

MES

| | | |
|---|---|---|
| Appearance | pale brown clear liquid | |
| Density 15° C. | 907 kg/m³ | ASTM 4502 |
| Pour point | 3° C. | ASTM D97 |
| Viscosity 40° C. | 200 +/− mm²/sec. | ASTM D445 |
| Viscosity 100° C. | 15 +/− 2 mm²/sec. | ASTM D445 |
| Refractive index 20° C. | 1.500 +/− 0.005 | ASTM D2159 |
| Viscosity density constant | 0.845 +/− 20 | ASTM D2140 |
| Carbon type: | | ASTM D2140 |
| Aromatic | 11-17% | |
| Naphthenic | 25-32% | |
| Paraffinic | 54-68% | |
| Glass transition temperature | −58 +/− 3° C. | ASTM E1356-98 |
| Flashpoint | 220° C. min. | ASTM D92 |
| Water content | 0.5% | ASTM D6304-98a |
| Content of polycyclic | 2.90% max. | IP346 |
| aromatic compounds | | |

TDAE

| | | |
|---|---|---|
| Appearance | pale brown liquid | |
| Density 15° C. | 0.943 kg/m³ | ASTM 4502 |
| Pour point | 0° C. max. | ASTM D97 |
| Viscosity 40° C. | 400 +/− 30 mm²/sec. | ASTM D445 |
| Viscosity 100° C. | 19 +/− 2 mm²/sec. | ASTM D445 |
| Refractive index 20° C. | 1.520 +/− 0.005 | ASTM D2159 |
| Viscosity density constant | 0.900 +/− 40 | ASTM D2140 |
| Carbon type: | | ASTM D2140 |
| Aromatic | 25-30% | |
| Naphthenic | 25-30% | |
| Paraffinic | 42-50% | |
| Glass transition temperature | −47 +/− 3° C. | ASTM E1356-98 |
| Flashpoint | 220° C. min. | ASTM D92 |
| Water content | 0.5% | ASTM D6304-98a |
| Content of polycyclic | 2.90% max. | IP346 |
| aromatic compounds | | |

Obviously, there may be added to the rubber mixtures according to the present invention, in addition to the aforementioned components a) to c) the following may also be added to the rubber mixtures, the known rubber auxiliary substances such as fillers, pigments, zinc oxide, stearic acid, vulcanization accelerators, vulcanization and/or crosslinking agents based on sulfur or peroxide, stabilizers, antioxidants, resins, oils, waxes as well as inhibitors.

Preferably, silicic acid and carbon black are added as fillers. Precipitated silicic acids and finely particulate furnace carbon blacks are more preferred.

The fillers and the aforementioned rubber auxiliary substances are used in the conventional amounts and are known to the person skilled in the art.

The rubber mixtures according to the present invention may be produced by intensively mixing the individual components with one another in mixing units suitable for this purpose, such as rollers or kneaders. The order of addition of the individual components is not critical and may be arbitrarily chosen. Obviously, it is in this connection also possible to mix in the mineral oil to be used completely or partially before the individual components a) and b).

The rubber mixtures according to the present invention may be vulcanized in a conventional manner, the vulcanization process being determined by the respective intended application of the rubber mixtures.

The rubber mixtures according to the present invention may be used for the production of all types of vulcanizates, for example for the production of tire parts such as tire treads and sidewalls, or for the production of industrial rubber articles such as belts, straps, conveyor belts, floor coverings, mats, seals, shoe soles and hoses.

It is preferred to use the rubber mixtures according to the present invention in tire manufacture, in particular for tire treads.

In the following examples, the properties of the rubber mixtures according to the present invention, the comparison rubber mixtures and the vulcanizates produced therefrom were measured as follows:

(1) The polymer composition of the termonomer was determined by means of IR spectroscopy.

(2) The Mooney viscosity of the rubbers was determined according to DIN 53523.

(3) The tensile strength of the vulcanizates was determined according to DIN 53504.

(4) The elongation at break of the vulcanizates was determined according to DIN 53504.

(5) The modulus of the vulcanizates at 100% and 300% elongation was determined according to DIN 53504.

(6) The hardness of the vulcanizates at 23° C. and 70° C. was determined according to DIN 53505.

(7) The rebound elasticity at 23° C. and 70° C. was determined according to DIN 53512.

(8) The abrasion of the vulcanizates was determined according to DIN 53516.

(9) The tan δ values of the vulcanizates was determined according to DIN 53513.

### EXAMPLES

The following components were used for the comparison rubber mixtures 1 and 2 as well as for the rubber mixtures 1, 2 and 3 according to the present invention:

SBR 1712 (Krynol® 1712, emulsion SBR, 23.5% styrene, 37.5% aromatic oil, manufacturer Bayer Elastomeres),

SBR 1712 (emulsion SBR, 23.5% styrene, 37.5% MES oil),

SBR 1513 (Cariflex® 1513, emulsion SBR, 40% styrene, manufacturer DOW)

NSBR (rubber produced by emulsion polymerization, 58.5% butadiene, 20.3% styrene and 21.1% acrylonitrile, Mooney viscosity 49),

Renopal® 450 (aromatic mineral oil/plasticizer, manufacturer Fuchs Chemie),

MES oil (Catenex SNR®, manufacturer Shell)

Corax® N339 (carbon black, manufacturer Degussa Hüls AG),

Vulkasil S (silicic acid, Bayer AG),

Si 69® (bis-3-(triethoxysilylpropyl)tetrasulfide, manufacturer Degussa AG),

Stearic acid

ZnO (zinc oxide),

Sulfur

IPPD (Vulcanox® 4010, N-isopropyl-N′-phenyl-p-phenylenediamine, manufacturer Bayer AG)

6PPD (Vulcanox® 4020 N-(1,3-dimethylbutyl)-N′-phenyl-p-phenylenediamine, manufacturer Bayer AG),

DPB (Vulkacit® D, diphenylguanidine, manufacturer Bayer AG),

CBS (Vulkacit® CZ/C N-cyclohexyl-2-benzothiazylsulfenamide, manufacturer Bayer AG).

The individual parts by weight of the components are given in Tables 1 and 2.

The components were mixed in a kneader (Werner & Pfleiderer GK 1.5) at 50 r.p.m. The kneading temperature was 60° C. The vulcanization 10 accelerators were mixed in on a roller.

The results of the tests are given in Tables 1 and 2.

TABLE 1
(Carbon black mixture)

| | 1* | 2* | 3 |
|---|---|---|---|
| | 37.5% | 37.5% | 37.5% |
| | Aromatic Oil | MES Oil | MES Oil with NSBR |
| SBR 1712 (37.5% | 110 | 0 | 0 |
| aromatic oil) | | | |
| SBR 1712 (37.5% | 0 | 110 | 110 |
| MES oil) | | | |
| SBR 1513 | 20 | 20 | 0 |
| NSBR 20% ACN | 0 | 0 | 20 |
| Aromatic oil | 7.5 | 0 | 0 |
| MES oil | 0 | 7.5 | 7.5 |
| N-339 Carbon black | 50 | 50 | 50 |
| Stearic acid | 2 | 2 | 2 |
| Zinc oxide | 3 | 3 | 3 |
| IPPD | 1 | 1 | 1 |
| 6PPD | 1 | 1 | 1 |
| Sulfur | 2 | 2 | 2 |
| CBS | 1.5 | 1.5 | 1.5 |
| DPG | 0.2 | 0.2 | 0.2 |

Vulcanizate Properties

| | | | |
|---|---|---|---|
| Tensile strength (MPa) | 22.9 | 17.8 | 16.5 |
| Elongation at break | 683 | 573 | 533 |
| (%) | | | |
| M 100% (MPa) | 1.2 | 1.1 | 1.2 |
| M 300% (MPa) | 5.6 | 6 | 6.2 |
| Hardness 23° C. | 54 | 53 | 54 |
| Hardness 70° C. | 49 | 49 | 48 |
| Elasticity 23° C. | 33 | 38 | 33 |
| Elasticity 70° C. | 49 | 51 | 53 |
| DIN abrasion (mm³) | 170 | 124 | 108 |
| Tan delta 0° C. | 0.424 | 0.326 | 0.460 |
| Tan delta 60° C. | 0.162 | 0.148 | 0.147 |

*comparison

The person skilled in the art knows that a high tan δ value at 0° C. denotes a good wet-skid behavior, while a low tan δ value at 60° C. denotes a low rolling resistance.

Example 1 (comparison example) contains 37.5% aromatic oil. If the aromatic oil is replaced by MES oil in Example 2 (comparison example), the wet-skid behavior deteriorates (lower tan δ value at 0° C.). On the other hand, the abrasion resistance and rolling resistance (higher tan δ value at 60° C.) are improved. In Example 3, according to the present invention, the high styrene content SBR 1513 is replaced by the terpolymer (NSBR). Accordingly the abrasion resistance, wet-skid behavior and the rolling resistance are significantly improved compared to Example 1 (comparison example). Compared to Example 2 (comparison example), at the same rolling resistance, the wet-skid behavior and the rolling resistance are significantly improved. The rubber mixtures according to the present invention are clearly superior to those of the prior art.

TABLE 2
(Rubber/silicic acid mixture)

| | 4* | 5* | 6 |
|---|---|---|---|
| | 37.5% | 37.5% | 37.5% |
| | Aromatic Oil | MES Oil | MES Oil |
| SBR 1712 (37.5% aromatic | 110 | 0 | 0 |
| oil) | | | |
| SBR 1712 (37.5% MES oil) | 0 | 110 | 110 |
| SBR 1513 | 20 | 20 | 0 |
| NSBR 20% ACN | 0 | 0 | 20 |
| Aromatic oil | 7.5 | 0 | 0 |
| MES oil | 0 | 7.5 | 7.5 |
| N-339 Carbon black | 25 | 25 | 25 |
| Vulkasil S | 25 | 25 | 25 |
| Si69 | 2 | 2 | 2 |
| Stearic acid | 2 | 2 | 2 |
| Zinc oxide | 3 | 3 | 3 |
| IPPD | 1 | 1 | 1 |
| 6PPD | 1 | 1 | 1 |
| Sulfur | 2 | 2 | 2 |
| CBS | 1.5 | 1.5 | 1.5 |
| DPG | 0.2 | 0.2 | 0.2 |

Vulcanizate Properties

| | | | |
|---|---|---|---|
| Tensile strength (MPa) | 23.9 | 22.2 | 15.5 |
| Elongation at break (%) | 745 | 716 | 588 |
| M 100% (MPa) | 1.1 | 1 | 1.1 |
| M 300% (MPa) | 4.5 | 4.3 | 4.7 |
| Hardness 23° C. | 53 | 50 | 51 |
| Hardness 70° C. | 47 | 45 | 46 |
| Elasticity 23° C. | 36 | 39 | 35 |
| Elasticity 70° C. | 52 | 53 | 53 |
| DIN abrasion (mm³) | 211 | 172 | 132 |
| Tan delta 0° C. | 0.423 | 0.309 | 0.435 |
| Tan delta 60° C. | 0.151 | 0.133 | 0.136 |

*comparison

The person skilled in the art knows that mixtures of various fillers can also be used. In these cases too, the rubbers according to the present invention are superior to the prior art. In this connection, the substitution of the aromatic oil by MES oil leads to a deterioration in the wet-skid behavior (compare Examples 4 and 5, both comparison examples). In Example 6 according to the present invention, the replacement of ESBR 1513 by the terpolymer (NSBR) leads to a marked improvement in the properties of abrasion resistance, wet-skid behavior and rolling resistance. Compared to Example 4 (comparison example), the abrasion resistance, wet-skid behavior (higher tan δ value at 0C) and rolling resistance.(lower tan δ value at 60° C.) and compared to Example 5 (comparison example) the abrasion resistance and wet-skid behavior are all improved. The rubber mixtures according to the present invention are clearly superior to those of the prior art.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

1. Rubber mixtures comprising at least
a) a non-polar rubber,
b) a terpolymer comprising an olefinically unsaturated nitrile, a vinyl aromatic compound and a conjugated diene, and
c) a mineral oil that contains a DMSO extract of ≦3 wt. %, the component a) being present in amounts of 1 to 99 parts by weight, the component b) in amounts of 1 to 99 parts by weight and the component c) in amounts of 1 to 50 parts by weight, in each case referred to the total amount of rubber.

2. Rubber mixtures according to claim 1, wherein component a) is present in amounts of 5 to 95 parts by weight, component b) in amounts of 5 to 95 parts by weight and component c) in amounts of 5 to 40 parts by weight in the rubber mixtures.

3. Rubber mixtures according to claim 1, wherein said non-polar rubber is selected from the group consisting of natural rubbers, polybutadiene rubbers, styrene-butadiene rubbers, polyisoprene rubbers, isoprene-butadiene rubbers, isoprene-butadiene-styrene rubbers, and ethylene-propylene-diene rubbers.

4. Rubber mixtures according to claim 1, wherein said terpolymer is built up from 1,3-butadiene or 2-methyl-1,3-butadiene or mixtures thereof, as well as from styrene and acrylonitrile.

5. Industrial rubber articles comprising rubber mixtures which comprises at least
a) a non-polar rubber,
b) a terpolymer comprising an olefinically unsaturated nitrile, a vinyl aromatic compound and a conjugated diene, and
c) a mineral oil that contains a DMSO extract of ≦3 wt. %, the component a) being present in amounts of 1 to 99 parts by weight, the component b) in amounts of 1 to 99 parts by weight and the component c) in amounts of 1 to 50 parts by weight, in each case referred to the total amount of rubber.

6. Industrial rubber articles according to claim 5, wherein said article is a tire or tire structural part.
